(19) United States
(12) Patent Application Publication
(10) Pub. No.: US 2023/0420843 A1
(43) Pub. Date: Dec. 28, 2023

(54) PHASE SHIFTER AND ANTENNA DEVICE

(71) Applicant: NOKIA SOLUTIONS AND NETWORKS OY, Espoo (FI)

(72) Inventors: Jun ZHANG, Hangzhou, Zhejiang (CN); Hongjun DENG, Guangdong (CN); Tao LENG, Hangzhou, Zhejiang (CN); Yuanhao WANG, Hangzhou, Zhejiang (CN)

(21) Appl. No.: 18/036,249

(22) PCT Filed: Nov. 19, 2020
(86) PCT No.: PCT/CN2020/130023

§ 371 Date: May 10, 2023

(51) Int. Cl. H01Q 3/32; H01Q 1/24; H01P 1/18

(52) U.S. Cl. CPC H01Q 3/32; H01Q 1/246; H01P 1/184

(57) ABSTRACT

Embodiments of the present disclosure relate to a phase shifter, an antenna device and a base station. The phase shifter comprises: a substrate comprising first conductive members, a movable assembly, and an adjusting assembly. The movable assembly comprises a second conductive member electronically coupled to first conductive members, and is adapted to move relative to the substrate in a first direction to shift a phase of an electrical signal output by the phase shifter. The adjusting assembly is coupled to the movable assembly and adapted to move the movable assembly to enable an alignment of the second conductive member and the first conductive members; or a change of a force applied by movable assembly to the substrate. In this way, the phase shifter is provided with an error-adjustment mechanism, and the antenna device as well as the base station including these phase shifters can achieve an increased accuracy and consistency.

### FIELD

Embodiments of the present disclosure generally relate to the field of telecommunication and in particular, to a phase shifter, an antenna device and a base station.

### BACKGROUND

In the communications area, a phase shifter (PS) is commonly used in an antenna device to improve the range and accuracy of the antenna beam scan. With the phase shifter, the number of the antenna elements in the antenna device can be reduced, which may in turn save the cost and power consumption of the antenna device.

In recent antenna technologies, various phase shifters have been proposed. For example, a digital phase shifter may comprise diodes and other peripheral circuits to shift phases of signals. Another proposed PS includes a first printed circuit board (PCB), a second PCB in parallel to the first PCB, and a third PCB bending between the first and second PCBs to couple to ends of the first and second PCBs. By moving the first or second PCB in a parallel direction, the phase shifters may continuously shift phases of signals. Improved solutions of phase shifters are still needed.

### SUMMARY

In general, example embodiments of the present disclosure provide a phase shifter, an antenna device comprising the phase shifter and a base station.

In a first aspect, there is provided a phase shifter. The phase shifter comprises a substrate, a movable assembly and an adjusting assembly. The substrate comprises a group of first conductive members. The movable assembly comprises a second conductive member electronically coupled to the group of first conductive members, and the movable assembly is adapted to move relative to the substrate in a first direction to shift a phase of an electrical signal output by the phase shifter. The adjusting assembly is coupled to the movable assembly and adapted to move the movable assembly to enable at least one of: an alignment of the second conductive member and the group of first conductive members; or a change of a force applied by the movable assembly to the substrate.

In a second aspect, there is provided an antenna device. The antenna device comprises an antenna array and a phase shifter. The phase shifter comprises a substrate, a movable assembly and an adjusting assembly. The substrate comprises a group of first conductive members. The movable assembly comprises a second conductive member electronically connected to the group of first conductive members, and the movable assembly is adapted to move relative to the substrate in a first direction to shift a phase of an electrical signal output by the phase shifter. The adjusting assembly is coupled to the movable assembly and adapted to move the movable assembly to enable at least one of: an alignment of the second conductive member and the group of first conductive members; or a change of a force applied by movable assembly to the substrate.

In a third aspect, there is provided a base station. The base station comprises an antenna device according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A-1C illustrates possible arrangements of a phase shifter;

FIG. 2 illustrates an example communication network in which example embodiments of the present disclosure may be implemented;

FIG. 3 illustrates a block diagram of an antenna device according to some example embodiments of the present disclosure;

FIG. 4 illustrates a stereoscopic view of a phase shifter according to some example embodiments of the present disclosure;

FIG. 5 illustrates an exploded view of a phase shifter according to some example embodiments of the present disclosure;

FIG. 6 illustrates a top view of a substrate of the phase shifter according to some example embodiments of the present disclosure;

FIG. 7A illustrates a top view of a movable plate and an elastic member of the movable assembly according to some example embodiments of the present disclosure;

FIG. 7B illustrates a top view of an alternative implementation of the movable plate and the elastic member of the movable assembly according to some example embodiments of the present disclosure;

FIG. 7C illustrates a bottom view of the movable plate and the elastic member of the movable assembly according to some example embodiments of the present disclosure;

FIG. 8A illustrates a top view of a housing of the movable assembly according to some example embodiments of the present disclosure;

FIG. 8B illustrates a bottom view of a housing of the movable assembly according to some example embodiments of the present disclosure;

FIG. 8C illustrates a bottom view of a housing of the movable assembly according to some example embodiments of the present disclosure;

FIG. 9 illustrates a stereoscopic view of an example adjusting member included in the adjusting assembly according to some example embodiments of the present disclosure;

FIG. 10 illustrates a top view of an enclosure of the phase shifter according to some example embodiments of the present disclosure;

FIG. 11A illustrates a cross-section view of the phase shifter taken along line A-A of FIG. 4 according to some example embodiments of the present disclosure;

FIG. 11B illustrates a cross-section view of an alternative implementation of the phase shifter taken along line A-A of FIG. 4 according to some example embodiments of the present disclosure;

FIG. 12A illustrates a cross-section view of the phase shifter taken along line B-B of FIG. 4 according to some example embodiments of the present disclosure; and

FIG. 12B illustrates a cross-section view of an alternative implementation of the phase shifter taken along line B-B of FIG. 4 according to some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “some example embodiments,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with some example embodiments, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as 5G New Radio (NR), Long Term Evolution (LTE), LTE-Advanced (LTE-A), Wideband Code Division Multiple Access (WCDMA), High-Speed Packet Access (HSPA), Non-terrestrial network (NTN), Internet of Things (IoT), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems, including but not limited to a terrestrial communication system, a non-terrestrial communication system or a combination thereof. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio head (RH), a remote radio head (RRH), a relay, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not be limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HIVID), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Various phase shifters are widely used in the radio product line. For example, multiple phase shifters are coupled to an antenna array of a base station (e.g., a gNB) for adjusting phases of electrical signals. Now communication technologies have evolved to the fifth generation new radio, which is also referred to as 5G NR, and the antenna device is typically comprised of a larger antenna array including massive antenna elements (AEs).

By way of example, the antenna device used in a radio cellular network often includes an antenna array that contains 192 AEs (96 dual polarized patches) to synthesize a desired beam pattern. Every three AEs may share a 3-in-1 feeding network and a port which is coupled to a transmit-receive unit (TRU) of the antenna device. In other words, the antenna array with 192 AEs is electrically connected to 64 TRUs. The TRU is adapted to adjust the phase and amplitude of each port during a beamforming process. On the one hand, the number of TRUs will affect the range and accuracy of beamforming. On the other hand, the increased number of TRUs may lead to an increase in cost and power consumption.

In the example above, if the number of TRUs is reduced from 64 to 32, the cost and power consumption of the antenna device will be halved. In this case, every 6 AEs will share a port and a TRU, which means the number of TRUs arranged in each column of the antenna array will be reduced from 4 to 2, and the number of TRUs arranged in each row still remains 8. Due to the reduced number of TRUs, such a layout has a limited range and accuracy of beam scan in a vertical direction. As a result, there is a demand on decreasing the number of TRUs and meanwhile keeping the beamforming ability of the antenna device.

To improve the range and accuracy of beam scan, a hybrid beamforming system is introduced to the antenna device by integrating one or more phase shifters (PS). These phase shifters may be controlled by extra circuits and mechanical structures to obtain a desired beam scan angle in a vertical direction. As such, the beamforming process will be affected by the digital TRU and the analogue PS together. The phase shifter normally includes a fixed PCB and a movable PCB, and each of the two PCBs includes at least one conductive member, for example, a microstrip line (MSL). The phase shifter adjusts the phase of the input electrical signal by the movement of the movable PCB relative to the fixed PCB, resulting in a change of a total length of the conductive members provided by the fixed PCB and the movable PCB.

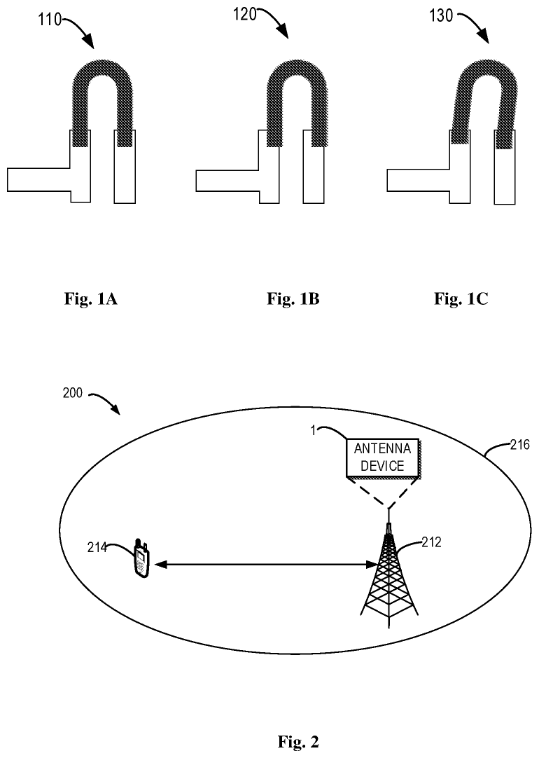

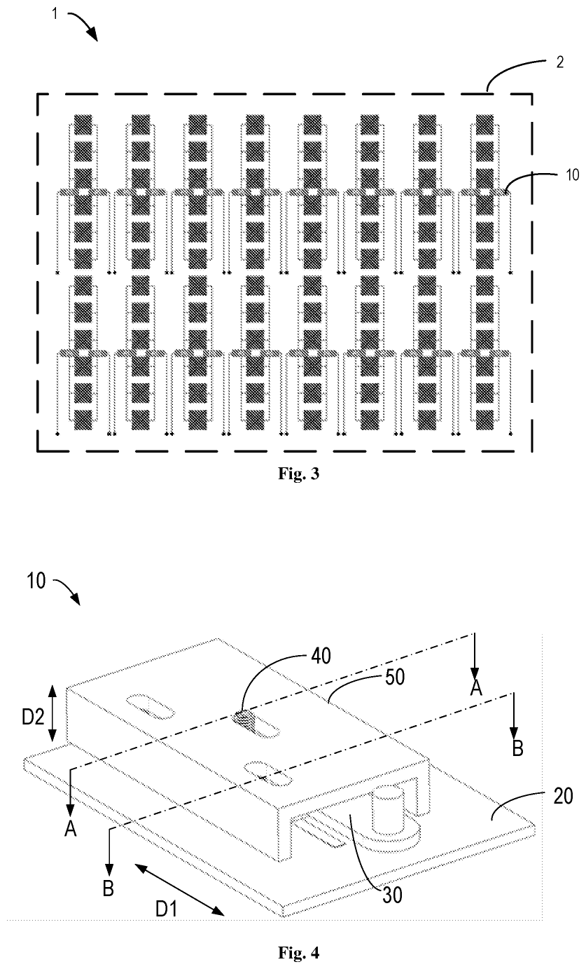

FIG. 1A shows an ideal arrangement 110 of the phase shifter. As shown in FIG. 1A, a pair of MSLs may be two MSLs arranged on the fixed PCB in parallel, and a U-shaped MSL may be the MSL arranged on the movable PCB. The U-shaped MSL and the pair of the MSLs in parallel are aligned face to face and electrically connected with each other. The electrical signal is input into one of the pair of the MSLs, and output from another of the pair of the MSLs. As the U-shaped MSL moves relative to the pair of MSLs, the total length of the MSL changes since the total length is the sum of the lengths provided by the pair of MSLs and the U-shaped MSL, resulting in shifting the phase of the electrical signal output by the phase shifter.

During manufacture of such a phase shifter, there may be a mismatch of the fixed PCB and the movable PCB during the assembly process of the phase shifter. FIGS. 1B-1C show possible mismatch arrangements 120 and 130 of the phase shifter. As shown in FIG. 1B, the U-shaped MSL on the movable PCB is arranged to be partially aligned with the pair of the MSLs on the fixed PCB, which may lead to mismatch of the impedance. As shown in FIG. 1C, the U-shaped MSL on the movable PCB may be deflected at a certain angle relative to the pair of the MSLs on the fixed PCB, resulting in the phase error and mismatch of the impedance. Sometimes, both of the mismatches can coexist in the phase shifter.

During a service life of the antenna device, it may be difficult to keep the consistency and accuracy of a large number of phase shifters integrated in an antenna device. A poor consistency of the mechanical alignment of the various sub-parts of one or more phase shifter may lead to a series of drawbacks, such as, a reduced antenna gain, a high sidelobe level, a poor range of beam scan, and so on. There is a demand to keep the same phase and amplitude output by the phase shifters.

According to the example embodiments of the present disclosure, there is provided an improved phase shifter and an antenna device comprising the phase shifter. The phase shifter comprises a substrate, a movable assembly and an adjusting assembly. The substrate comprises a group of first conductive members. In some example embodiments, the first conductive members may include transmission lines, such as, microstrip lines. It will be appreciated that in other example embodiments that the microstrip lines could be realized by alternative types of conductive members, for example and not limited to, stripline, coplanar waveguide, slotline, coplanar strips, and so on, some of which may be electromagnetically coupled together to form the overall phase shifter transmission line length. The movable assembly comprises a second conductive member electrically coupled to the group of first conductive members, and the movable assembly is adapted to move relative to the substrate in a first direction to shift a phase of an electrical signal output by the phase shifter. The adjusting assembly is coupled to the movable assembly and adapted to move the movable assembly to enable at least one of: an alignment of the second conductive member and the group of first conductive members; or a change of a force applied by the movable assembly to the substrate. With the adjusting assembly, a contact tightness of the two PCBs of the phase shifter and the alignment of first conductive members on the two PCBs can be accurately adjusted. As such, all the phase shifters are capable of providing the same phase and amplitude outputs after they are assembled and the PCBs aligned during manufacture of the phase shifter before being assembled on the antenna device. Such a consistency can be kept during the service life of the antenna device.

Principle and embodiments of the present disclosure will be described in detail below with reference to the accompanying drawings. Reference is first made to FIG. 2, which illustrates an example communication network 200 in which example embodiments of the present disclosure may be implemented. The communication network 200 may include at least one communication apparatus, such as a network device 212. The network device 212 may include at least one antenna device 1 for providing a serving area 216 by using different frequency bands in both an uplink (UL) and a downlink (DL). The serving area of the network device 212 may be also called a cell 216. In some example embodiments, the network device 212 may be a base station. Alternatively, in some other example embodiments, the antenna device 1 may be deployed in other communication devices.

The communication network 200 also includes one or more terminal devices, such as a terminal device 214. The terminal device 214 is served and communicated with the network device 212 as long as the terminal device 214 is located within the cell 216. In communication systems, an UL refers to a link in a direction from a terminal device to a network device, and a DL refers to a link in a direction from the network device to the terminal device.

It is to be understood that the number of network devices and terminal devices is only for the purpose of illustration without suggesting any limitations. The communication network 200 may include any suitable number of network devices and terminal devices adapted for implementing embodiments of the present disclosure.

Communications in the communication network 200 may be implemented according to any proper communication protocol(s), comprising, but not limited to, cellular communication protocols of the first generation (1G), the second generation (2G), the third generation (3G), the fourth generation (4G) and the fifth generation (5G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Reference is now made to FIG. 3, which illustrates a block diagram of an antenna device 1 according to some example embodiments of the present disclosure. The antenna device 1 includes an antenna array 2 comprising 96 AEs and 32 phase shifters 10. It should be understood that the antenna device 1 may include one or more additional elements or components not shown in Fig.2. For example, a driving component (e.g., a motor) and respective mechanical part can be integrated into the antenna device 1 for driving the phase shifters.

As shown in FIG. 3, the antenna array 2 of the antenna device 1 includes 96 AEs arranged in 12 rows and 8 columns. Every 3 AEs are coupled to a phase shifter 10. The 32 phase shifters 10 are divided into an upper group and a lower group which are mechanically connected to the driving component by one or more rods, with each of the groups including 16 phase shifters 10.

The phase shifters 10 are manually mounted on the antenna device 1. As previously mentioned, there is at least one MSL arranged on the fixed PCB and at least one MSL arranged on the movable PCB. FIG. 1A shows an ideal arrangement of the phase shifter 100. As shown in FIG. 1A, a pair of MSLs in parallel may be the MSLs arranged on the fixed PCB, and a U-shaped MSL may be the MSL arranged on the movable PCB. The U-shaped MSL and the pair of the MSLs in parallel are aligned face to face and are electrically coupled with each other. The electrical signal is input into one of the pair of the MSLs. As the U-shaped MSL moves relative to the pair of the MSLs, the total length of the MSL changes since the total length is the sum of the lengths provided by the pair of MSLs and the U-shaped MSL, resulting in shifting the phase of the electrical signal output by the phase shifter 10.

FIG. 4 illustrates a stereoscopic view of a phase shifter 10 according to some example embodiments of the present disclosure. The phase shifter 10 may be an example implementation of the phase shifter of FIG. 3. The phase shifter 10 comprises a substrate a movable assembly 30, an adjusting assembly 40 and an enclosure 50. As shown in FIG. 4, the substrate 20 supports the remaining portions of the phase shifter 10, including the movable assembly 30, the adjusting assembly 40 and enclosure 50. The enclosure 50 is fixed on the substrate 20 and receives the movable assembly 20 and at least a part of the adjusting assembly 40. By way of non-limiting examples, the enclosure 50 may be soldered or screwed on the substrate 20.

The substrate 20 may be the fixed PCB, while the movable assembly 30 may include the movable PCB, which is adapted to move relative to the substrate 20. Each of the substrate 20 and the movable assembly 30 further includes respective one or more first conductive members, which will be described in details below.

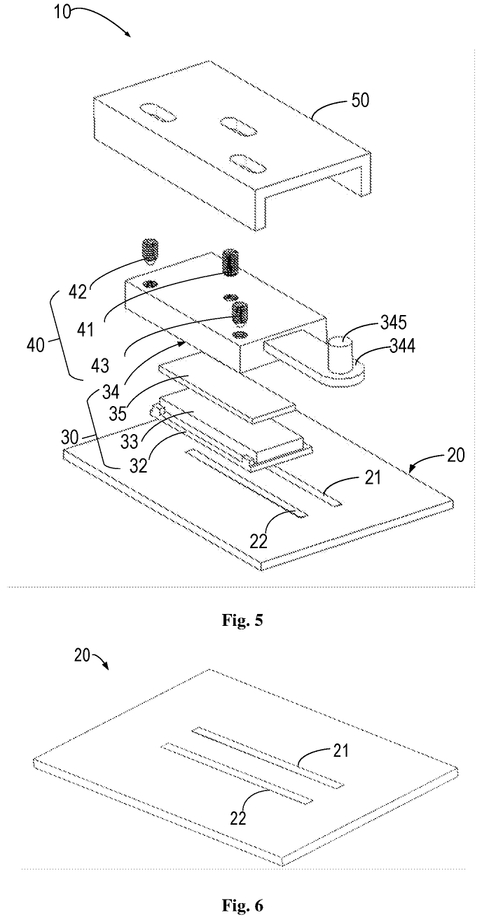

FIG. 5 illustrates an exploded view of the phase shifter 10 according to some example embodiments of the present disclosure. The phase shifter 10 may be an example implementation of the phase shifter of FIG. 3. The phase shifter 10 comprises the substrate which may be made by polymer, PCB, or any other suitable material.

As shown in FIG. 5, the substrate 20 includes a group of first conductive members 21 and 22. The pair of first conductive members 21 and 22 are arranged in parallel and spaced apart from each other for transmission of electrical signals (e.g., the radio frequency signals) that are received from respective AEs of the antenna device 1. In some example embodiments, the substrate 20 supports the first conductive members 21 and 22, and the first conductive members 21 and 22 may be fixed on the surface of the substrate 20 for example, by printing or plating. One of the first conductive members 21 and 22 may act as an input terminal of the electrical signals, while the other one may act as an output terminal of the electrical signals.

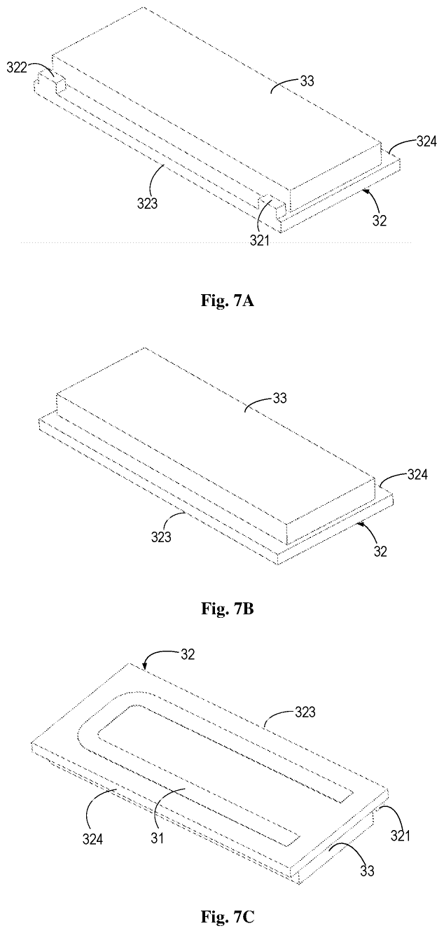

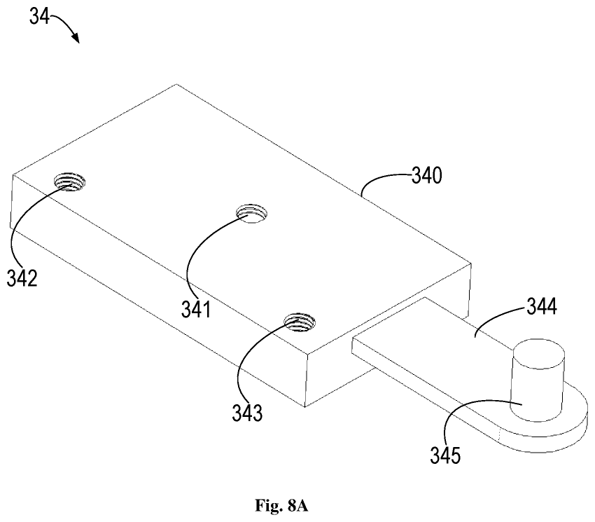

The phase shifter 10 further includes the movable assembly 30 which is adapted to move relative to the substrate 20 in a first direction D1. The relative movement in the first direction can be driven by a cantilever 344, which will be discussed in details below. By way of example, the first direction D1 may be parallel or nearly parallel to the direction along which the first group of conductive members 21 and 22 are arranged on the surface of the substrate 20. As discussed above, with the relative movement of the substrate 20 and the movable assembly 30, the phase of the electrical signal output by the phase shifter 10 can be shifted. The movable assembly 30 includes a second conductive member (not shown) electronically connected to the group of first conductive members 21 and 22, a movable plate 32, and an elastic member 33 and a housing 34. In some example embodiments, the movable assembly 30 may further include a pressure plate 35. The pressure plate 35 may be provided between the housing 34 and the elastic member 33. Although the movable plate 32 is illustrated in FIG. 5, this is only for the purpose of illustration without suggesting any limitations. Other movable plates are also possible. For example, FIGS. 7B and 11B illustrate different movable plates, which will be described below.

As shown, the housing 34 may be connected to a cantilever 344 fixed to the housing 34 at a first end of the cantilever 344. The cantilever 344 includes a pin 345 at its second end which is opposite to the first end. The pin 345 may be designed to match a pathway of a mechanical part of a driving component (not shown), such that the pin 345 can be flexibly moved in the pathway to force the movable assembly 30 to move relative to the substrate 20.

The phase shifter 10 further includes an adjusting assembly 40. In some example embodiments, the adjusting assembly 40 may include at least one adjusting member 41 to 43, which will be discussed in details below. The adjusting assembly 40 is coupled to the movable assembly 30 and adapted to move the movable assembly 30 relative to the substrate 20. Depending on either one movement or a combination of movements of at least one respective adjusting member, the movement driven by the adjusting assembly 40 may enable the alignment of the second conductive member relative to the group of first conductive members 21 and 22, additionally or alternatively, a change of a force applied by movable assembly 30 to the substrate 20.

In some example embodiments, the phase shifter 10 may include the enclosure 50. As mentioned above, the enclosure 50 is fixed on the substrate 20 and receives the movable assembly 30. Details of the configuration of the phase shifter 10 will be described below with respect to FIGS. 6-12B. Although the phase shifter 10 is illustrated in FIG. 5, this is only for the purpose of illustration without suggesting any limitations. Other configurations for the phase shifters are possible. For example, FIGS. 7A-7B and 11A-11B illustrate different configurations of phase shifters.

FIG. 6 illustrates a stereoscopic view of a substrate 20 of a phase shifter 10 according to some example embodiments of the present disclosure. In some example embodiments, the substrate 20 includes a group of first conductive members 21 and 22. The first conductive members 21 and 22 are fixed on the surface of the substrate 20, for example, by printing or plating. One of the first conductive members 21 and 22 may act as an input terminal of the electrical signals, while the other one may act as an output terminal of the electrical signals. The substrate 20 may be made of insulation materials and provided for supporting the remaining portions of the phase shifter 10.

FIG. 7A illustrates a top view of the movable plate 32 and the elastic member 33 of the movable assembly 30 as shown in FIG. 5 according to some example embodiments of the present disclosure. The movable plate 32 includes a first surface where the elastic member 33 is fixed on. The first surface of the movable plate 32 is opposite to a second surface of the movable plate 32 that is electrically coupled to the substrate 20. The elastic member 33 is arranged between the movable plate 32 and the housing 34.

The movable plate 32 further includes at least one protrusion 321 and 322, which protrude from a first side 323 in a second direction D2 perpendicular to the movable plate 32. As shown in FIG. 7A, the movable plate 32 and the elastic member 33 are not aligned at a second side 324 of the movable plate 32 that is opposite to the first side 323.

In some example embodiments, the movable plate 32 may not include the protrusions 321 and 322, as shown in FIG. 7B, which illustrates a top view of an alternative implementation of the movable plate 32 and the elastic member 33 of the movable assembly 30 as shown in FIG. 5 according to some example embodiments of the present disclosure.

FIG. 7C illustrates a bottom view of the movable plate and the elastic member of the movable assembly 30 according to some example embodiments of the present disclosure. As shown in FIG. 7C, the movable assembly 30 further includes the second conductive member 31, which is arranged on the second surface of the movable plate 32. The second conductive member 31 is aligned and electrically coupled to the group of first conductive members 21 and 22 to form a circuit. The MSL length associated with the first conductive members 21 and 22 and the second conductive member 31 changes with the movement of the movable plate 32 relative to the substrate 20.

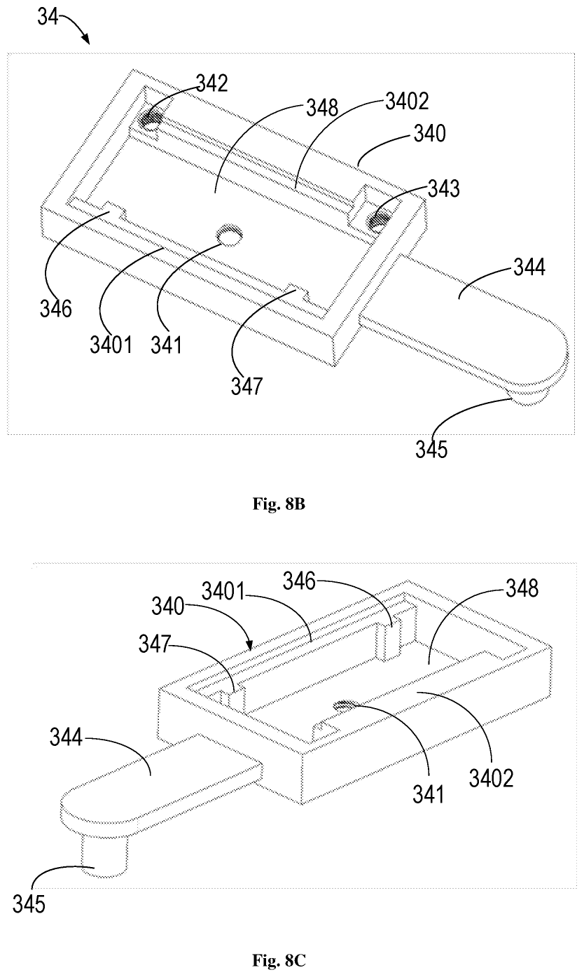

FIG. 8A illustrates a top view of a housing 34 of the movable assembly 30 according to some example embodiments of the present disclosure. The housing 34 receives the movable assembly 30 to allow the movable assembly 30 to move towards the movable plate 32. As shown in FIG. 8A, the housing 34 includes a main shell 340, at least one of engaging holes 341-343, the cantilever 344 and the pin 345. The at least one engaging hole 341-343 is/are provided on the main shell 340 and match the adjusting assembly. The main shell 340 further comprises a cavity, which will be described in details in connection with FIGS. 8B-8C.

FIGS. 8B-8C illustrate bottom views of the housing 34 of the movable assembly 30 according to some example embodiments of the present disclosure. As shown, a cavity 348 is provided in the main housing 340 and is adapted to receive at least the movable plate 32 and the elastic member 33. In some example embodiments, the cavity 348 may be further adapted to receive the pressure plate 35. The housing 34 further includes protrusions 346 and 347 arranged on a first wall 3401 of the main housing 340. The housing 34 further comprises a second wall 3402 arranged opposite to the first wall.

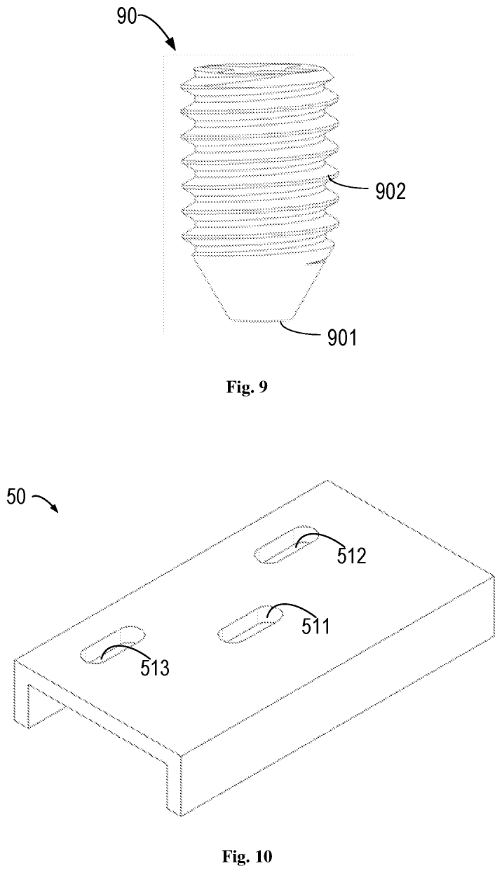

FIG. 9 illustrates a stereoscopic view of an example adjusting member 90 included in the adjusting assembly 40 according to some example embodiments of the present disclosure. The adjusting member 90 is given as an example configuration of one or more of the adjusting members 41 to 43. In the example embodiments, the adjusting assembly may include one or more adjusting members 90.

As shown in FIG. 9, the adjusting member 90 includes an end 901 and a body 902, and is engaged in a respective engaging hole on the housing 34 (e.g., the engaging holes 341 to 343) to move the movable plate 32 relative to the substrate 20. The adjusting member 90 is also engaged in a respective through hole on the enclosure 50, which will be described in details below.

By way of example, the adjusting member 90 is shown as a screw with screw thread on the body 902 and a tapered end 901. It should be understood that such a particular implementation is given for illustrative purpose only, and any other suitable implementation of the adjusting member is also possible. For example, in some example embodiments, the adjusting member 90 may be a cylinder. For example, the adjusting member 90 may alternatively be a bolt. Additionally or alternatively, the adjusting members 41 to 43 may have the same or different configurations as shown in FIG. 9.

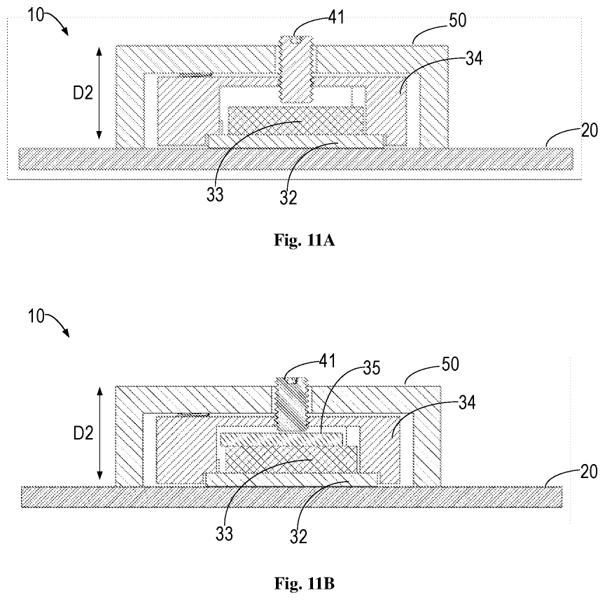

FIG. 10 illustrates a top view of the enclosure 50 of the phase shifter 10 according to some example embodiments of the present disclosure. The enclosure 50 is fixed on the substrate 20 and receives the movable assembly 30. The enclosure 50 further includes at least one through hole adapted to receive the adjusting assembly 40. As shown in FIG. 10, the enclosure 50 may include the through holes 511 to 513 and one or more of the adjusting members 41 to 43 may pass through the respective at least one through hole 511 to 513. As such, the movable assembly 30 can be moved relative to the substrate 20 in a certain distance limited by one or more of the through holes 511 to 513.

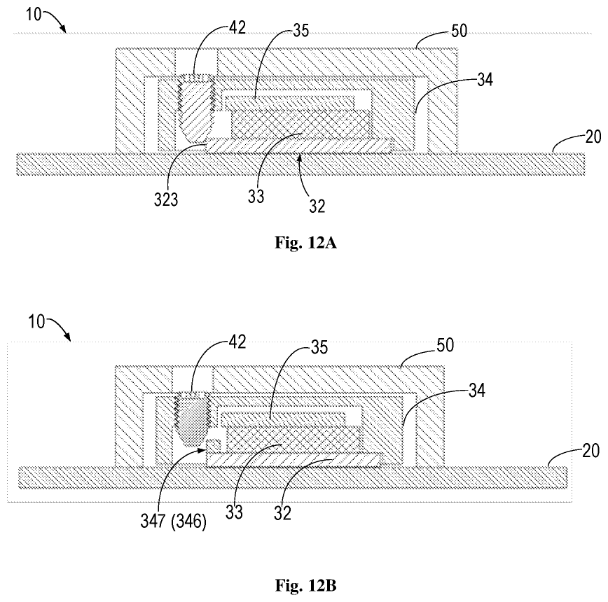

FIG. 11A illustrates a cross-sectional view of the phase shifter 10 taken along line A-A of FIG. 4 according to some example embodiments of the present disclosure. As shown in FIG. 11A, the enclosure 50 is fixed on the substrate 20 and receives the housing 34. The adjusting member 41 of the adjusting assembly 40 passes through the through hole 511. The movable plate 32 and the elastic member 33 are received within the cavity of the housing 34. The first adjusting member 41 is engaged in the engaging hole 341 and adapted to move towards or away from the movable plate 32 to change the force applied by the movable assembly 30 to the substrate 20. There are tiny gaps between the movable plate 32 and the housing 34, which allow the movable plate 32 to move within the cavity of the housing 34, which will be described in connection with FIGS. 12A-12B.

The elastic member 33 is provided between the adjusting member 41 and the movable plate 32. As such, if the first adjusting member 41 moves towards the movable plate 32, the elastic member 33 is compressed to provide a proper pressure to the movable plate 32, and the force applied by the movable assembly 30 to the substrate 20 is increased. In this case, a sliding friction force between the movable plate 32 and the substrate 20 will be also increased.

In a case where the first adjusting member 41 moves away from the movable plate 32, the force is decreased and thus the sliding friction force between the movable plate 32 and the substrate 20 will be also decreased. As such, the adjusting assembly 40 enables a change of the force applied by the movable assembly 30 to the substrate 20. It is to be understood that the first adjusting member 41 may be designed to be in a shape that is different from the shape shown in FIG. 11A, for example, a screw with a tapered end.

FIG. 11B illustrates a cross-sectional view of an alternative implementation of the phase shifter 10 taken along line A-A of FIG. 4 according to some example embodiments of the present disclosure. As shown in FIG. 11B, in addition to the elements shown in FIG. 11A, the movable assembly 30 of the phase shifter 10 further includes the pressure plate 35, which may be arranged to float between the movable plate 32 and the elastic member 33.

By way of example, in a case where the first adjusting member 41 moves towards the movable plate 32, for example, by being screwed tightly, the pressure plate 35 moves downward to press the elastic member 33, which compresses the movable plate 32 and the substrate 20. In a case where the first adjusting member 41 moves away from the movable plate 32 by being screwed loosely, the pressure on the elastic member 33 will be decreased and thus the force applied by the movable assembly 30 to the substrate 20 will be also decreased. In this way, the sliding friction between the movable plate 32 and the substrate 20 can be adjustable.

FIG. 12A illustrates a cross-sectional view of the phase shifter 10 taken along line B-B of FIG. 4 according to some example embodiments of the present disclosure. As shown in FIG. 12A, the adjusting assembly 40 may further include the second adjusting member 42 and the third adjusting member 43 (the third adjusting member 43 is not visible in the illustration of FIG. 12A since it is obscured by the second adjusting member 42). The second adjusting member 42 and the third adjusting member 43 are arranged on a first side 323 of the movable plate 32 and spaced apart from each other along the first direction D1. The second adjusting member 42 and the third adjusting member 43 are engaged in the engaging holes 342 and 343 respectively and each include a tapered end. In the example embodiments, the first side of the movable plate 32 extends in the first direction D1.

As previously mentioned, since there are gaps between the first wall and the second wall of the housing 34 and the movable plate 32, the movable plate 32 can be driven by at least one of the adjusting members 42 and 43 to move within the cavity of the housing 34. Specifically, the adjusting members 42 and 43 are adapted to abut against the first side in response to a movement toward the movable plate 32. As the adjusting members 42 and 43, either alone or in combination, move towards the movable plate 32, the movable plate 32 is pushed towards the second wall of the housing 34, and the elastic member 33 is arranged to abut against the inner wall of the housing 34 to be elastically deformed. As such, the second conductive member 31 on the movable plate 32 may move relative to the first conductive members 21 and 22 on the substrate 20, as either or both of the adjusting members 42 and 43 move towards the movable plate 32.

By moving at least one of the second adjusting member 42 and the third adjusting member 43, for example, by screwing the adjusting members tightly or loosely to various extent, it may cause a translation movement or a rotation movement of the second conductive member 31 relative to the first conductive members 21 and 22. In this way, the second conductive member 31 can be moved to align with the overlap with the first conductive members 21 and 22. In other words, the second adjusting member 42 and the third adjusting member 43 are provided for adjusting the second conductive member 31 to overlap with the first conductive members 21 and 22 as much as possible.

As an example, by moving the second adjusting member 42 and the third adjusting member 43 towards the movable plate 32 for the same distance, it may cause a translational movement of the second conductive member 31 relative to the first conductive members 21 and 22. As another example, by moving either the second adjusting member 42 or the third adjusting member 43, or alternatively, by moving them for different distances, it may cause a rotational movement of the second conductive member 31 relative to the first conductive members 21 and 22.

Further, by moving the second adjusting member 42 and the third adjusting member 43, either alone or in combination, away from the movable plate 20, the elastic member33 after elastic deformation tends to revert to its original shape, which will drive the movable plate 32 away from the second wall of the housing 34.

FIG. 12B illustrates a cross-sectional view of an alternative implementation of the phase shifter 10 taken along line B-B of FIG. 4 according to some example embodiments of the present disclosure. As shown in FIG. 12B, in addition to the elements shown in FIG. 11A, the movable plate 32 further includes the protrusions 346 and 347, and the second adjusting member 42 and the third adjusting member 43 are adapted to abut against the respective protrusions 346 and 347 with a movement towards the movable plate 32. With the configuration of FIG. 12B, the travel distance of the adjusting member 42 and 43 can be extended, which may further improve an adjustment accuracy of the phase shifter.

It should be understood that the adjusting assembly 40 can include one or more of the adjusting members 41 to 43, and the adjusting members 41 to 43 can be used separately or in any combination. Although three adjusting members are illustrated, other numbers of adjusting members is possible, including only one adjusting member.

According to the example embodiments of the present disclosure, by moving one or more adjusting members of the adjusting assembly 40, the phase shifter can flexibly adjust the matching and alignment of the movable PCB and the fixed PCB, and thereby realizing a desired phase. In addition, after adjustment, the adjusting members of phase shifter can be fixed on the housing, for example, by glued in respective engaging holes, so that the desired phase can be kept, which may further improve the consistency among a plurality of phase shifters in the antenna device.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A phase shifter comprising:
a substrate comprising a group of first conductive members;
a movable assembly comprising a second conductive member electronically coupled to the group of conductive members, and the movable assembly configured to move relative to the substrate (in a first direction (D1) to shift a phase of an electrical signal output by the phase shifter; and
an adjusting assembly coupled to the movable assembly and configured to move the movable assembly to enable at least one of:
an alignment of the second conductive member relative to the group of the first conductive members; and
a change of a force applied by the movable assembly to the substrate.

2. The phase shifter of claim 1, wherein the movable assembly further comprises:
a movable plate on which the second conductive member is disposed;
a housing receiving the movable plate and comprising at least one engaging hole configured to receive the adjusting assembly to allow the movable assembly to move towards the movable plate; and
an elastic member disposed between the movable plate and the housing, such that an elastic deformation of the elastic member caused by a movement of the adjusting assembly applies the force to the movable plate towards the substrate.

3. The phase shifter of claim 2, wherein the adjusting assembly comprises:
a first adjusting member engaged in a first engaging hole of the at least one engaging hole and configured to move towards or away from a movable plate to change the force applied by movable assembly to the substrate.

4. The phase shifter of claim 2, wherein the adjusting assembly further comprises:
at least one adjusting member engaged in the at least one engaging hole and disposed over a first side of the movable plate, each adjusting member comprising a tapered end adapted to abut against the first side in response to a movement toward the movable plate, the first side extending in the first direction (D1).

5. The phase shifter of claim 4, wherein the at least one adjusting member comprises a second adjusting member and a third adjusting member spaced apart from each other along the first direction (D1), and wherein at least one of the second adjusting member and the third adjusting member is configured to be moved towards the movable plate to cause a translational movement or a rotation movement of the second conductive member relative to the first conductive members.

6. The phase shifter of claim 4, wherein the elastic member is fixed on the movable plate.

7. The phase shifter of claim 4, wherein the elastic member is disposed to abut against an inner wall of the housing to be elastically deformed in response to the movement of the second conductive member relative to the group of the first conductive members.

8. The phase shifter of claim 4, wherein the movable plate comprises at least one protrusion protruding from the first side in a second direction (D2) perpendicular to the movable plate and
each of the at least one adjusting member is configured to abut against the respective protrusion with a movement towards the movable plate.

9. The phase shifter of claim 1, further comprising:
an enclosure fixed on the substrate and receiving the movable assembly

10. The phase shifter of claim 9, wherein the enclosure comprises at least one through hole configured to receive the adjusting assembly.

11. The phase shifter of claim 1, wherein the group of the first conductive members comprises a pair of wires disposed on the substrate in parallel, and the second conductive member comprises a U-shaped wire.

12. An antenna devic, comprising:
an antenna array comprising a plurality of antenna elements; and
a phase shifter according to claim 1, the phase shifter electrically coupled to the antenna array.

13. A base station comprising an antenna device according to claim 12.
